(19) United States
(12) Patent Application Publication
(10) Pub. No.: US 2019/0149866 A1
(43) Pub. Date: May 16, 2019

(54) Streaming Video Management System, Method, and Computer Program Product Thereof

(71) Applicant: VAS Creative Co, Ltd, Taipei City 115 (TW)

(72) Inventor: Tien-Ming Wang, Taipei City (TW)

(21) Appl. No.: 15/928,151

(22) Filed: Mar. 22, 2018

(30) Foreign Application Priority Data
Nov. 14, 2017 (TW) 106139372

(51) Int. Cl. H04N 21/258; H04N 21/254; H04N 21/262

(52) U.S. Cl. CPC H04N 21/25808; H04N 21/26208; H04N 21/2541

(57) ABSTRACT

A streaming video management system is used between a video supply end and a video display end. The video supply end can output a streaming video signal. The streaming video management system includes a management module, a bandwidth detection module and a network delivery selection interface. The management module is used for receiving and managing the streaming video signal. The bandwidth detection module is used to detect a transmission bandwidth of the video display end. The network delivery selection interface has a plurality of content delivery network nodes. According to the transmission bandwidth, the management module is used to transmit the streaming video signal via one of the content delivery network nodes to the video display side by the network delivery selection interface.

### BACKGROUND OF THE INVENTION

### 1. Field of the Invention

The present invention relates to a streaming video management system and a streaming video management method thereof, particularly to a streaming video management system and a streaming video management method thereof able to provide content delivery network flexibly.

### 2. Description of the Related Art

As technology advances, various types of Over the Top (OTT) platform operators continue to increase. To ensure the smooth video playback, the OTT platform operators usually deliver video signals is through Content Delivery Network or Content Distribution Network (CDN) provided by service providers. The Content Delivery Network refers to a computer network system interconnected via the Internet, using the server closest to each user to deliver music, pictures, videos, applications, and other files faster and more reliably to users, to provide users with high-performance, scalable and low-cost Internet content. However, in the prior art, the OTT platform operators only rely on the Content Delivery Network provided by a single service provider, and cannot adjust to changes in bandwidth or other network environments. When a service provider of the Content Delivery Network is shut down, interrupted or terminated, the client's video streaming service will be affected.

Accordingly, it is necessary to devise a new streaming video management system and a streaming video management method thereof to solve the problems in the prior art.

### SUMMARY OF THE INVENTION

It is a major Objective of the present ntion to provide a streaming video management system which has the effect of providing a content delivery network flexibly.

It is another major objective of the present invention to provide a streaming video managementmethod used in the aforementioned system.

To achieve the above objectives, the streaming video management system in the present invention is used between a video supply end and a video display end. The video supply end can output a streaming video signal. The streaming video management system includes a management module, a bandwidth detection module, and a network delivery selection interface. The management module is electrically connected to the video supply end for receiving and managing the streaming video signal. The bandwidth detection module is electrically connected to the video display end for detecting a transmission bandwidth of the video display end. The network delivery selection interface is electrically connected to the management module, and has a plurality of content delivery network nodes, wherein according to the transmission bandwidth, the management module is used to transmit the streaming video signal via one of the content delivery network node to the video display end by the network delivery selection interface.

A streaming video management method in the present invention includes the following steps: detecting a transmission bandwidth of a video display end; receiving a streaming video signal; and transmitting the streaming video signal via one of the content delivery network node to the video display end according to the transmission bandwidth.

The present invention further provides a computer program product stored in a computer-readable medium for reading and execution to achieve the streaming video management method described above.

### BRIEF DESCRIPTION OF THE DRAWINGS

FIG. 1 is an architecture diagram of a streaming video management system in the present invention; and

FIG. 2 is a flowchart showing steps in a streaming video management method according to the present invention.

### DETAILED DESCRIPTION OF THE PREFERRED EMBODIMENT

Hereafter, the technical content of the present invention will be better understood with reference to preferred embodiments.

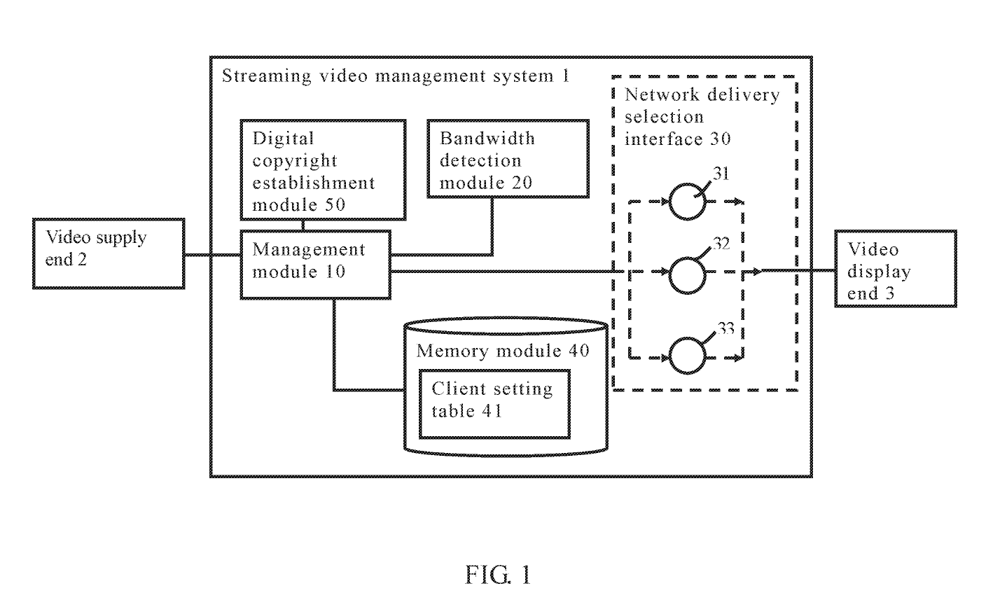

Hereafter, please first refer to FIG. 1 which is an architecture diagram of a streaming video management system in the present invention.

A streaming video management system 1 in the present invention is used for network communication between a video supply end 2 and a video display end 3. The video supply end 2 can output a video signal. The source of video signal may be Video On Demand (VOD), linear streaming, a linear channel or webcast interface generated live video, but the present invention s not limited thereto. The video display end 3 may be an end-user device for viewing, such as television, smartphone, tablet, laptop, monitor, etc., but the present invention is not limited thereto.

The streaming video management system 1 includes a management module 10, a bandwidth detection module 20, a network delivery selection interface 30, a memory module 40, and a digital copyright establishment module 50. The management module 10 is electrically connected to the video supply end 2, for receiving and managing the streaming video signal, The bandwidth detection module 20 is electrically connected to the video display end 3, for detecting a transmission bandwidth of the video display end 3. The network delivery selection interface 30 is electrically connected to the management module 10. As shown in FIG. 1, in an embodiment of the present invention, the network delivery selection interface 30 has a plurality of content delivery network nodes 31, 32, 33, but the preset ntion is not limited to the number, The different plurality of content delivery network nodes 31, 32, 33 are provided by different Internet service providers and the supported bandwidth or performance is not the same.

In an embodiment of the present invention, the management module 10 is used to automatically assign based on the transmission bandwidth detected by the bandwidth detection module 20 to transmit the streaming video signal via one of the content delivery network nodes 31, 32, 33 to the video display end 3 by using the network delivery selection interface 30. For example, when the video display end 3 has a wider transmission bandwidth, the management module 10 controls the streaming video signal to be transmitted to the video display end 3 via the content delivery network node 31 that supports a wider transmission bandwidth for users to have better audio and video experiences. Conversely, if the video display end 3 has a smaller transmission bandwidth, the management module 10 controls the streaming video signal to he transmitted to the video display end 3 via the content delivery network node 32 that supports a smaller transmission bandwidth to keep the video signal playback fluency. Also, when any of the content delivery network nodes31, 32, 33 of the network delivery selection interface 30 fails, for example, when the content delivery network node 31 failure occurs, the management module 10 may transmit the streaming video signal that is to be transmitted via the content delivery network node 31 to the video display end 3 via another content delivery network node 32. In addition, a backup system (shown) with the same function may he provided in the streaming video management system 1 at the same time to avoid any module failure in the original system and service unable to be provided normally, but the present invention is not limited thereto.

The memory module 40 of the streaming video management system 1 is used to store a client setting table 41 which corresponds to different settings of different client's video display end 3. The management module 10 further selects to transmit the streaming video signal to the video display end 3 via one of the content delivery network nodes according to the client setting table 41. For example, if the client is a paid member, the management module 10 controls the streaming video signal to be sent to the video display end 3 via the content delivery network node 31 with a wider bandwidth. if the client is a regular member, the management module 10 controls the streaming video signal to be transmitted to the video display end 3 via the content delivery network node 32 with a smaller support bandwidth. in addition, it can also be determined according to the transfer amount set by a client or user fee. When the client's transmission or usage fees reach the upper limit, the management module 10 controls the streaming video signal to change the node transmitted to the video display end 3 or change the network service provider. It is also possible to set the node or network service provider to connect to in the client setting table 41 according to the area where the client is located. The present invention does not limit the setting items or contents in the client setting table 41.

The streaming video management system 1 may also include a digital copyright establishment module 50. After receiving streaming video, user can choose whether to use the digital copyright establishment is module 50 to add a digital copyright to the streaming video signal, and then transmit the video to the video display end 3, but the present invention is not limited thereto.

It should be noted that each module in the streaming video management system 1 may be configured as a hardware device, software program in combination with hardware device, or firmware in combination with hardware device. For example, a computer program product may be stored in a computer readable medium and read and executed to achieve the functions of the present invention, and may also be configured in a cloud environment or a virtual server. However, the present invention is not limited in the manner described above. Additionally, the preferred embodiment of the present invention described here is only illustrative, To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may not necessarily exist between two of any modules.

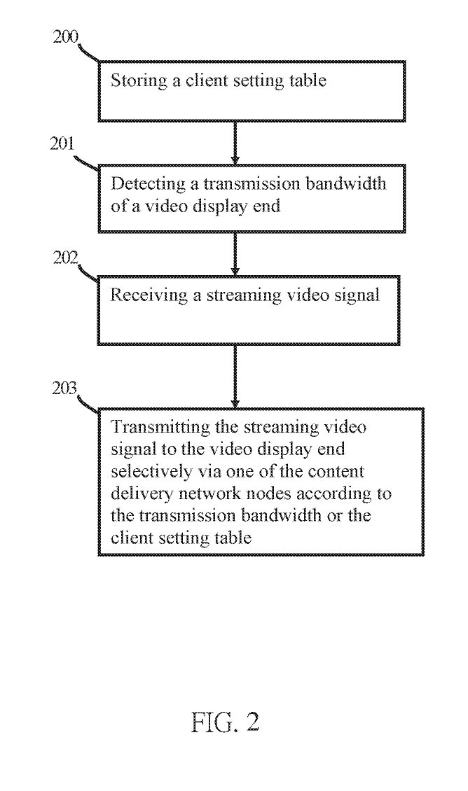

Then, please refer to FIG. 2 which is a flowchart showing steps in a streaming video management method according to the present invention. It should be noted here that although the streaming video management method in the present invention is described below by using the streaming video management system 1 as an example, the streaming video management method of the present invention is not limited to the streaming video management system 1 using the above configuration.

First, in Step 200: Storing a client setting table.

At first, the memory module 40 is used to store a client setting table 41 corresponding to different settings of the video display end 3 of different clients.

Next, in Step 201: Detecting a transmission bandwidth of the video display end,

The bandwidth detection module 20 detects a transmission bandwidth of the video display end 3.

Then, in Step 202: Receiving a streaming video signal.

At this time, the streaming video management system 1 receives the streaming video signal from the video supply end 2. At the same time, the digital copyright establishment module 50 may also add a digital copyright to the streaming video signal, hut the present invention is not limited thereto.

Then, in Step 203: Transmitting the streaming video signal to the video display end selectively via one of the content delivery network nodes according to the transmission bandwidth or the client setting table.

The management module 10 is used to transmit the streaming video signal to the video display end 3 selectively via one of the content delivery network nodes 31, 32, 33 according to the transmission bandwidth. Also, the management module 10 may select to transmit the streaming video signal to the video display end 3 via one of the content delivery network nodes 31, 32, 33 according to the client setting table 41. By this, it is possible to flexibly assign the content delivery network nodes 31, 32, 33 to be transmitted through.

In addition, when any of the content delivery network nodes of the network delivery selection interface 30 fails, the management module 10 selects to transmit the streaming video signal to the video display end 3 via another content delivery network node.

It should be noted here that, the streaming video management method in the present invention is not limited to the above sequence of steps, and the order of the above steps may also be changed as long as the objective of the present invention can be achieved.

In this way, the streaming video management system 1 can flexibly adjust the content delivery network to prevent the situation that video content cannot be played normally due to a single content delivery network error.

It should be noted that the preferred erribodiments of the present invention described above are only illustrative. To avoid Is redundancy, all the possible combinations of changes are not documented in detail. However, it shall be understood by those skilled in the art that each of the modules or elements described above may not be necessary. For the implementation of the present invention, the present invention may also contain other detailed, co tional modules or elements. Each module or component is likely to be omitted or modified depending on the needs. Other modules or elements may not necessarily exist between two of any modules. All without departing from the scope of the invention are defined solely by the appended claims.

1. A streaming video management system comprising:
a management module electrically connected to a video supply end that outputs a streaming video signal, with the management module configured to receive and manage the streaming video signal;
a bandwidth detection module electrically connected to a video display end, with the bandwidth detection module configured to detect a detected transmission bandwidth of the video display end; and
a network delivery selection interface electrically connected to the management module with the network delivery selection interface having a plurality of content delivery network nodes,
wherein the management module is configured to:
select one of the plurality of content delivery network nodes, using the network delivery selection interface, according to the detected transmission bandwidth of the video display end, and
transmit the streaming video signal to the video display end via a selected one of the plurality of content delivery network nodes.

2. The streaming video management system as claimed in claim 1, further comprising a memory module configured to store a client setting table corresponding to the video display end, wherein the management module is configured to select the selected one of the plurality of content delivery network nodes according to the client setting table and to transmit the streaming video signal to the video display end via the selected one of the plurality of content delivery network nodes.

3. The streaming video management system as claimed in claim 1, wherein when the at least one of the plurality of content delivery network nodes of the network delivery selection interface fails, the management module is configured to transmit the streaming video signal to the video display end via another content delivery network node.

4. The streaming video management system as claimed in claim 1, further comprising a digital copyright establishment module configured to add a digital copyright to the streaming video signal and then transmit the streaming video signal to the video display end.

5. The streaming video management system as claimed in claim 1, further comprising a backup system.

6. A streaming video management method comprising:
detecting a detected transmission bandwidth of a video display end;
receiving a streaming video signal from a video supply end outputting the streaming video signal; and
assigning the streaming video signal to be transmitted to the video display end to a select one of a plurality of content delivery network nodes according to the detected transmission bandwidth.

7. The streaming video management method as claimed in claim 6, further comprising:
storing a stored client setting table corresponding to the video display end; and
transmitting the streaming video signal to the video display end selectively via the selected one of the plurality of content delivery network nodes according to the stored client setting table.

8. . The streaming video management method as claimed in claim 6, further comprising transmitting the streaming video signal to the video display end via another content delivery network node when a failure of the at least one of the content delivery network nodes occurs.

9. The streaming video management method as claimed in claim 6, further comprising adding a digital copyright to the streaming video signal and transmitting the streaming video signal to the video display end.

10. A computer program stored in a non-transitory computer readable medium to be read and executed to achieve the method as claimed in claim 6.
